(19) United States
(12) Patent Application Publication
(10) Pub. No.: US 2009/0222797 A1
(43) Pub. Date: Sep. 3, 2009

(54) APPARATUS AND METHOD FOR PROVIDING A TRIGGER

(75) Inventor: HARRY SIEBERT, Puchheim (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Neubiberg (DE)

(21) Appl. No.: 12/040,325

(22) Filed: Feb. 29, 2008

(51) Int. Cl. G06F 9/44

(52) U.S. Cl. 717/128; 717/127

(57) ABSTRACT

A real-time trigger apparatus and method for using the same including a trigger logic block configured to output a trigger signal, and at least one reference register configured to store a traced value calculated by the trigger logic block, wherein the trigger signal is based at least in part on the traced value.

### FIELD OF THE INVENTION

The present invention relates in general to debug trigger apparatuses in data processing systems and more particularly, to an adaptable debug trigger apparatus.

### BACKGROUND

Presently, debug operations such as stopping program execution, toggling a pin for measurement, generating trace messages, and the like, are initiated in response to a specific value or variable stored in a register or any memory. Alternatively, the debug operation can be triggered in response to a value or variable stored in a special function register such as an A/D conversion result.

In addition to triggering debug operations on a variable, there are times when the debug operation is initiated in response to a change between successive samples. Two approaches are used to calculate a change in real time to debug hardware and software, an instrumentation approach and a pipelined analysis approach.

Using the instrumentation approach, which generally refers to modifying the software on the target machine, the debugged software is modified to explicitly calculate a change. The change value is then stored as a special or virtual variable. The special or virtual variable is then analyzed by the trigger logic. This approach cannot be used in situations where the code is fixed or where timing is critical, such as when storage is in non-volatile memory or in timing-critical applications such as DSP based filtering. In these cases, by the time the trigger calculation is completed, the system has passed the point where the trigger should have been output.

Using pipelined analysis, a variable is traced and the change is calculated off chip either in a quasi-parallel manner using a fast debugging host computer or as a post-mortem analysis after the trigger value has been reached. Of course, the post-mortem analysis fails to provide real time debug data. Parallel or off-chip processing is similar to the instrumentation approach above wherein by the time the trigger calculation is completed, the system has passed the point where the trigger should have been output.

FIG. 1 depicts a known debug trigger apparatus 100. The debug trigger apparatus 100 includes a register file 10 and a comparator block 20. The register file 10, which stores the parameters for the comparator block 20, includes a sign register 12, a mask register 14, a reference register 16, and a range register 18. The comparator block 20 includes calculation blocks 22, 24, 26, and 28. Comparator block 20 utilizes the parameters stored in register file 10 to determine if a debug trigger 40 should be output by analyzing data received via bus 30. Typically, bus 30 is a 32-bit bus.

In operation, comparator block 20 performs a fixed calculation to determine when the debug trigger is to be output. A data word from bus 30 is provided to calculation block 22 that masks the incoming data word so that only the relevant data remains. In operation, the mask is typically implemented using a logical AND. The relevant data is presented to the sign extend block 24 that replicates the sign bit to all of the high-order non-relevant bits in the word using the sign value picked from a bit position stored in sign register 12. Next, calculation block 26 subtracts a reference value X, stored in reference register 16 from the traced value, which is the sign extended data output from calculation block 24. Typically, the value stored in reference register 16 is the constant lower bound of the range comparator. Finally, the calculation block 28 determines if the difference determined in calculation block 26 is within the range Y, set forth in range register 18. Depending on this comparison, a trigger signal 40 is output. It should be noted that the circuit shown in FIG. 1 maintains constant values in the register file 10.

In operation, the circuit of FIG. 1 has the overall equation

trigger=(0≦(d(t)−X)≦Y) Equation 1

Thus, according to Equation 1, a trigger signal is output when the data at time t, less the reference amount X is not within the range between 0 and Y, the upper bound of the range.

### SUMMARY

A real-time trigger apparatus including a trigger logic block configured to output a trigger signal, and at least one reference register configured to store a traced value calculated by the trigger logic block, wherein the trigger signal is based at least in part on the traced value.

### BRIEF DESCRIPTION OF THE FIGURES

FIG. 1 depicts a known debug trigger apparatus.

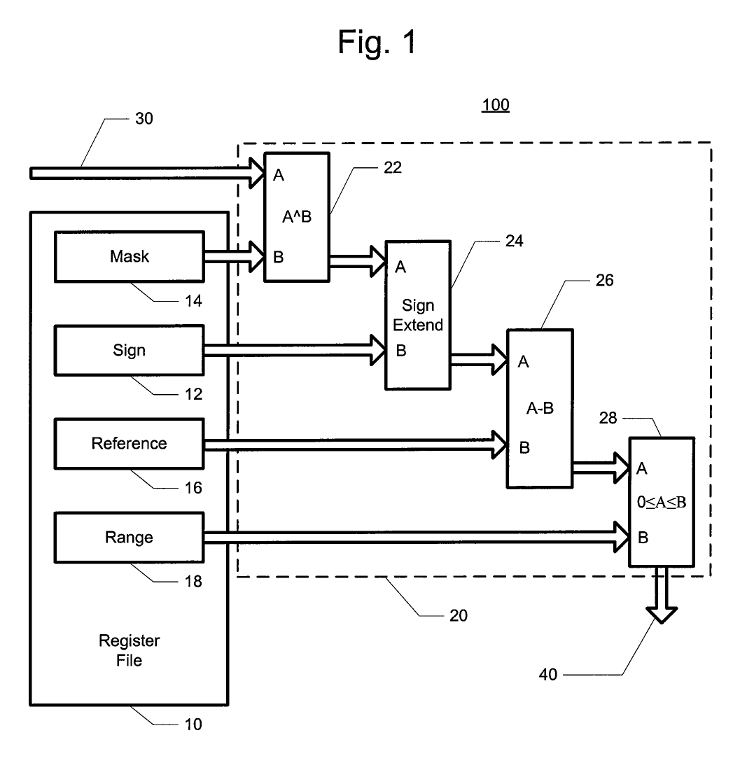

FIG. 2 depicts a debug trigger apparatus in accordance with one embodiment of the invention.

FIG. 3 depicts a debug trigger apparatus in accordance with one embodiment of the invention.

FIG. 4 is a flowchart illustrating a method of outputting a debug trigger signal in accordance with an embodiment of the present invention.

### DETAILED DESCRIPTION

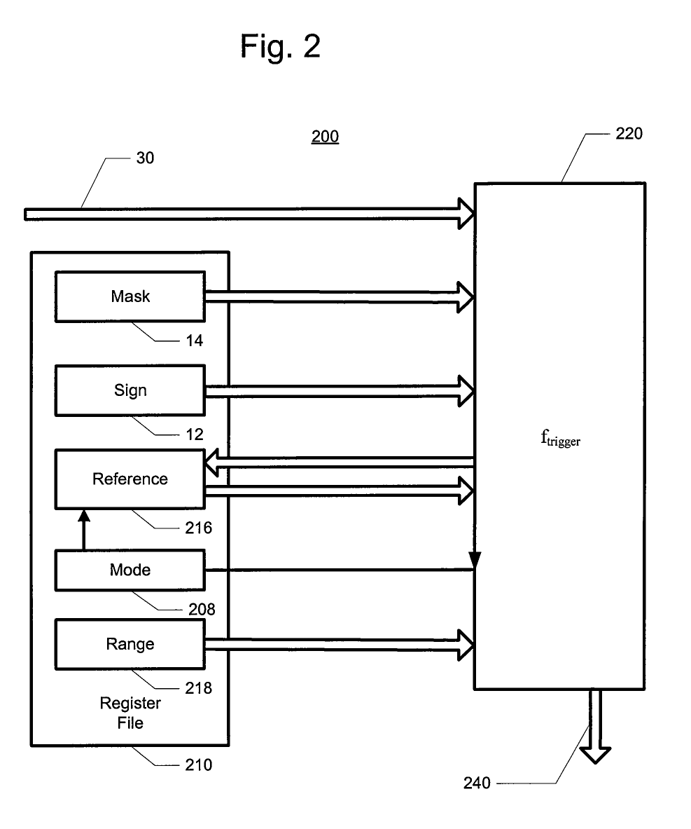

FIG. 2 depicts a real-time debug trigger apparatus 200 in accordance with an embodiment of the present invention. Specifically, debug trigger apparatus 200 is an on-chip debug trigger apparatus that provides calculation of a trigger function non-intrusively. The debug trigger apparatus 200 includes a register file 210 and a trigger logic block 220. Register file 210 includes a sign register 12, a mask register 14, a reference register 216, a mode register 208, a range register 218, and an input 212. Trigger logic block 220 includes various internal functional blocks adapted to implement a specified trigger function.

As shown, data in a reference register 216 can be overwritten with a traced value provided by trigger logic block 220. The currently stored value is used during the trigger calculation to determine if a trigger signal 240 should be output. The value is overwritten in part under the control of mode register 208 via reload control line 214. A control signal, which indicates the point of time when the value is overwritten, is based on information from the surrounding system such as validity of input, address comparators, and/or the trigger signal 240 itself, and the like. The newly stored variable is used in subsequent calculations to determine when the trigger signal 240 is output. It should be noted that the trigger logic block 220 is adapted to calculate a difference between variables, the absolute value of a difference, a sum of variables, or any other mathematical relationship between variables. It should be noted that the calculation can also yield a nonlinear result such as a dB scale for sound data, or saturation.

Register file 210 includes input 212 that provides data to modify the contents of the registers in register file 210. Input 212 provides an update signal for mode register 208, that indicates when an update to the reference register 216 is required. This update signal is generally produced under system control. In one embodiment, input 212 is a bus similar to bus 30. In one embodiment, reference register 216 and/or the other registers in register file 210 provide values to a plurality of trigger logic blocks.

In addition to input 212 acting as a programming interface, input 212 is preferably configured to, as discussed above, provide a control signal to mode register 208 as to when the update signal is generated and output via reload control line 214 to reference register 216. Typical data provided to mode register 208, which is used in part to determine when an update signal provided via reload control line 214 is generated, includes new data on bus 30, address comparator match, and the like. It should be noted that while a single input 212 is shown, there can be a plurality of input lines providing data to register file 210, including data provided to register file 210 via bus 30.

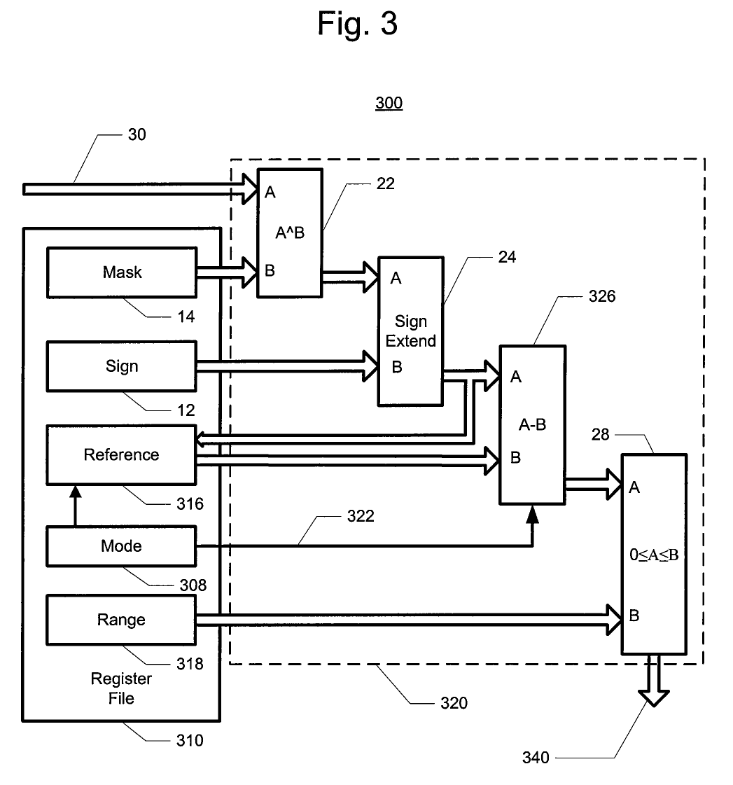

FIG. 3 depicts a debug trigger apparatus 300 in accordance with another embodiment of the present invention. Specifically, FIG. 3 depicts debug trigger apparatus 300 implemented as a difference comparator or Δ comparator. The debug trigger apparatus 300 includes a register file 310 and a trigger logic block 320. Register file 310 includes a sign register 12, a mask register 14, reference register 316, mode register 308, and a range register 318. An input bus 312 provides data to the register files. Trigger logic block 320 includes various internal functional blocks adapted to implement a specified trigger function. More specifically, the debug trigger apparatus 300 is adapted to implement the following debug functions:

trigger_rise=((0≦(d(t)−d(t−1))≦B)1:0) Equation 2a

trigger_fall=((0≦(d(t−1)−d(t))≦B)1:0) Equation 2b

In the embodiment shown in FIG. 3, a first calculation block 22 isolates the relevant data bits from a data word. Specifically, first calculation block 22 performs a logical AND using input data from bus 30 and a mask stored in mask register 14. Next, sign extend block 24 replicates the sign bit from the position stored in sign register 12 to all of the high-order non-relevant bits in the data word. Subtraction block 326 subtracts the data in the reference register 316 from the relevant data output from sign extend block 24 as required in Equation 2a or 2b. Finally, calculation block 28 determines if a debug trigger 340 should be output based at least in part on a value stored in range register 318 in accordance with Equation 2a or Equation 2b.

It should be noted that the debug trigger apparatus 300 is able to calculate the difference in subtraction block 326 both from a positive and negative slope. The mode register 308 provides data to the subtraction block 326 via input line 322 to distinguish between a positive and negative slope. Additionally, the data output from sign extend block 24 is provided to the reference register 316. Mode register 308 contains data that, in addition to determining when to negate the subtraction function to correct for positive or negative slope, also determines when the reference variable in reference register 316 should be updated. An update signal is provided to reference register 316 from mode register 308 via reload control line 314. The value stored in mode register 308 is determined by in accordance with the debug program, which is beyond the scope of the present disclosure.

Input 312 is configured to provide data to update one or more of the registers in register file 310. In accordance with the debug program or other system control, the update signal is calculated based on the setting of mode register 308 that controls when the data in reference register 316 is updated. Mask register 14 can be loaded with data to isolate various bits in the data word in bus 30. The range register 318 can also be updated. Input 312 is preferably a bus similar to bus 30. In another embodiment, bus 30 provides the update data to register file 310.

In addition to input 312 acting as a programming interface, input 312 is preferably configured to, as discussed above, provide a control signal to mode register 308 as to when the update signal is generated and output via reload control line 314 to reference register 316. Typical data provided to mode register 308, which is used in part to determine when an update signal provided via reload control line 314 is generated, includes new data on bus 30, address comparator match, and the like. It should be noted that while a single input 312 is shown, there can be a plurality of input lines providing data to register file 310, including data provided to register file 310 via bus 30.

While trigger logic block 320 has been discussed as being a difference block, it is not limited thereto. Alternatively, trigger logic block 320 can include or be implemented as another function such as a sum, absolute value, logarithmic function, or the like. Additionally, the trigger logic block 320 can be configured to analyze a relationship between different bits in a word. By using the debug trigger apparatus disclosed in either of FIGS. 2 and 3, calculations of a traced data object and use of the trace data value for comparison can be performed in real time.

The disclosed trigger apparatus provides a more flexible trigger output for a debug operation. For example, if the data being input on the bus 30 is the output of a counter, i.e., a sequential counter proceeding from 1 to 10, the mask stored in mask register 14 will isolate the specific bits that contain the count information. This isolated data will be processed by the sign extend function block so that the data bits other than the specific count bits will have the same value. This data word is then provided to reference register 316 so that it is updated with the current count value after each comparison. The range register 318 stores the step value, i.e., by 1 in the present example. If the counter of the present example was not sequential but instead stepped by 3, i.e., 0, 3, 6, 9 . . . , the range register would contain a 3. Thus, if there is a difference of more than the range, for example if the counter skips a value, the trigger will be activated.

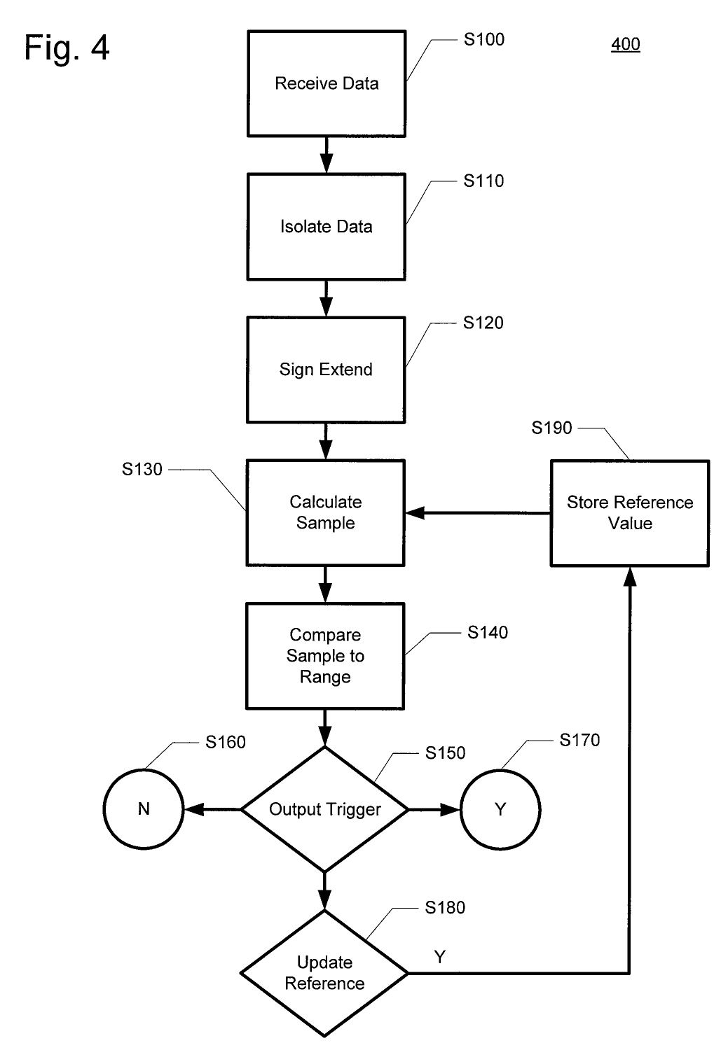

FIG. 4 is a flowchart 400 illustrating a method of outputting a debug trigger signal in accordance with an embodiment of the present invention. As shown, a data word is received by the apparatus (S100). At least one relevant data bit is isolated from the data word (S110). Various methods can be used to isolate the at least one relevant data including a logically ANDing a mask word and the data word. Next, a sign bit is replicated to all of the non-relevant bits to produce a traced value (S120). The system calculates a data sample based in part on the traced value and the value stored in the reference register (S130). The calculated sample value is then compared to a range value (S140). A determination is then made as to whether a debug trigger should be output (S150). If the sample is within the acceptable range no debug trigger is output (S160). Alternatively, if the sample is not within the acceptable range a debug trigger is output (S170) and the debug trigger then initiates a debug function. The system then determines if the stored reference value is to be updated (S180). This decision may be based on the arrival of a new value in (S100), the setting of a mode register, some other qualification from outside the scope of this trigger logic (e.g. an address comparator) or even on the trigger output (S170) itself. If the reference value is to be updated, the traced value is stored in the reference register (S190). It should be noted that because the debug trigger is determined in real-time, the debug function captures the most relevant data. While discussed in a particular order, it should be noted that the above steps are not necessarily carried out in that order. For example, the decision to update the reference value (S180) can be carried out at any time after the currently stored data is used to calculate the sample (S130). Alternatively, if a revised reference value is to be used to calculate the sample (S130), the reference value can be stored prior to that calculation.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof

1. A real-time trigger apparatus comprising:
a trigger logic block configured to output a trigger signal; and
at least one reference register configured to store a traced value calculated by the trigger logic block,
wherein the trigger signal is based at least in part on the traced value.

2. The real-time trigger apparatus of claim 1, further comprising a mode register configured to control data storage in the reference register.

3. The real-time trigger apparatus of claim 2, further comprising a range register, configured to provide the trigger logic block with a range value.

4. The real-time trigger apparatus of claim 3, wherein the traced value stored in the reference register and the range value are used to set an upper end or lower limit in the trigger logic block.

5. The real-time trigger apparatus of claim 1, further comprising a mask register configured to provide a mask value to the trigger logic block for extracting relevant bits from a data word input into the trigger logic block.

6. The real-time trigger apparatus of claim 5, wherein the trigger logic block calculates a difference between successive relevant bits.

7. The real-time trigger apparatus of claim 1, wherein the trigger logic block compares two variables from a data word input into the trigger logic block at different points of time.

8. The real-time trigger apparatus of claim 1, wherein the trigger logic block further comprises:
an extraction block configured to extract relevant bits of a word based at least in part on data stored in a mask register;
a sign function block configured to replicate a sign bit to all high-order bits of the word other than the relevant bits;
a function block configured to calculate a value based at least in part on the relevant bits and a value stored in a reference register; and
a trigger logic block configured to compare the output of the function block with a value based at least in part on a range value stored in a range register,
wherein the output of the sign function block is provided to the reference register.

9. The real-time trigger apparatus of claim 8, further comprising a mode register configured to determine when the output of the sign function block is stored in the reference register.

10. The real-time trigger apparatus of claim 8, wherein the function block calculates a difference between the relevant bit and the value stored in the reference register.

11. The real-time trigger apparatus of claim 10, further comprising a mode register configured to control writing data to the reference register.

12. The real-time trigger apparatus of claim 11, wherein the mode register is configured to control the kind of calculation in the function block.

13. A method of providing a real-time trigger comprising:
receiving a data word;
calculating an output designated by a calculation block based at least in part on the received data word and a value stored in a reference register;
storing a reference data based at least in part on the received data word in the reference register;
comparing the output of the calculation block with at least a value in a range register; and
outputting a trigger if the output of the calculation block exceeds the value in the range register.

14. The method of providing a real-time trigger of claim 13, further comprising:
providing an update signal to the reference register, wherein the update signal is configured to control the storing operation.

15. The method of providing a real-time trigger of claim 13, wherein the calculated output comprises calculating a difference.

16. The method of providing a real-time trigger of claim 15, wherein the calculated output is an absolute value.

17. The method of providing a real-time trigger of claim 15, wherein the calculated output is a sum.

18. The method of providing a real-time trigger of claim 13, wherein the comparing further comprises:
determining if the output of the calculation block is within an acceptable range and
outputting the trigger if the output of the calculation block is not within the acceptable range.

19. The method of providing a real-time trigger of claim 13, further comprising:
sign extending the relevant bits.

20. The method of providing a real-time trigger of claim 13, further comprising isolating relevant data bits in the received data word, by performing a logical AND operation.

21. The method of providing a real-time trigger of claim 20 wherein the logical AND operation ANDs the received data word with a mask.

22. A real-time trigger apparatus comprising:
a trigger logic block means for outputting a trigger signal; and
at least one reference register configured to store a traced value calculated by the trigger logic block means,
wherein the trigger signal is based at least in part on the traced value.

23. The real-time trigger apparatus of claim 22, wherein the trigger logic block means further comprises:
a first function means for extracting relevant bits of a word based in part on data stored in a mask register:
a second function means for calculating a value based in part on the relevant bits and the traced value; and
a trigger function means for comparing the output of the first function means with a value based in part of a range value stored in a range register.

24. The real-time trigger apparatus of claim 23, wherein the first function means is implemented as a logical AND.

25. The real-time trigger apparatus of claim 22, wherein the second function means calculates a difference between the relevant data bits and the traced value stored in the reference register.
